(19) United States
(12) Patent Application Publication
(10) Pub. No.: US 2025/0093519 A1
(43) Pub. Date: Mar. 20, 2025

(54) SERVER-BASED STATE SPACE REPRESENTATION (SSR) SERVICE ENHANCEMENT FOR REAL-TIME KINEMATIC (RTK) OR PRECISE POINT POSITIONING (PPP)

(71) Applicant: QUALCOMM Incorporated, San Diego, CA (US)

(72) Inventors: Yuxiang PENG, Sunnyvale, CA (US); Ning LUO, Cupertino, CA (US)

(21) Appl. No.: 18/468,595

(22) Filed: Sep. 15, 2023

(51) Int. Cl. G01S 19/07

(52) U.S. Cl. CPC G01S 19/07

(57) ABSTRACT

An example method for updating GNSS error correction data for global navigation satellite system (GNSS)-based positioning. The method performed by a server may comprise obtaining multiple GNSS measurements crowdsourced from one or more GNSS devices across a plurality of measurement epochs, determining GNSS measurement residuals using the multiple GNSS measurements and existing GNSS error correction data, and sending updated GNSS error correction data for GNSS-based positioning, wherein the updated GNSS error correction data is determined using the determined GNSS measurement residuals and the existing GNSS error correction data.

### BACKGROUND

### 1. Field of Disclosure

The present disclosure generally relates to the field of satellite-based positioning.

### 2. Description of Related Art

Global Navigation Satellite Systems (GNSS) positioning of mobile devices (e.g., consumer electronics, vehicles, assets, drones, etc.) can provide accurate positioning of a mobile device comprising a GNSS receiver. Traditional GNSS positioning provides accuracy on the order of a few meters, and more precise GNSS-based techniques can provide sub-meter accuracy. Precise Point Positioning (PPP) and Real Time Kinematic (RTK) are two types of GNSS-based positioning techniques that provide more precision. These techniques use additional correction information to achieve higher precision than traditional GNSS positioning. However, this correction information may not always meet the required standards for GNSS and may result in precision positioning performance that falls short of expectations.

### BRIEF SUMMARY

An example method for updating GNSS error correction data for global navigation satellite system (GNSS)-based positioning. The method performed by a server may comprise obtaining multiple GNSS measurements crowdsourced from one or more GNSS devices across a plurality of measurement epochs, determining GNSS measurement residuals using the multiple GNSS measurements and existing GNSS error correction data, and sending updated GNSS error correction data for GNSS-based positioning, wherein the updated GNSS error correction data is determined using the determined GNSS measurement residuals and the existing GNSS error correction data.

An example server for updating GNSS error correction data for global navigation satellite system (GNSS)-based positioning comprises a transceiver, a memory, and one or more processors communicatively coupled with the transceiver and the memory. The one or more processors may be configured to obtain multiple GNSS measurements crowdsourced from one or more GNSS devices across a plurality of measurement epochs, determine GNSS measurement residuals using the multiple GNSS measurements and existing GNSS error correction data, and send updated GNSS error correction data for GNSS-based positioning, wherein the updated GNSS error correction data is determined using the determined GNSS measurement residuals and the existing GNSS error correction data.

An example apparatus for updating GNSS error correction data for global navigation satellite system (GNSS)-based positioning. The apparatus may comprise means for obtaining multiple GNSS measurements crowdsourced from one or more GNSS devices across a plurality of measurement epochs, means for determining GNSS measurement residuals using the multiple GNSS measurements and existing GNSS error correction data, and means for sending updated GNSS error correction data for GNSS-based positioning, wherein the updated GNSS error correction data is determined using the determined GNSS measurement residuals and the existing GNSS error correction data.

An example non-transitory computer-readable medium storing instructions for RF sensing, the instructions may comprise code for obtaining multiple GNSS measurements crowdsourced from one or more GNSS devices across a plurality of measurement epochs, determining GNSS measurement residuals using the multiple GNSS measurements and existing GNSS error correction data, and sending updated GNSS error correction data for GNSS-based positioning, wherein the updated GNSS error correction data is determined using the determined GNSS measurement residuals and the existing GNSS error correction data.

This summary is neither intended to identify key or essential features of the claimed subject matter nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a Global Navigation Satellite System (GNSS), according to an embodiment.

FIG. 2 is a block diagram of a Precise Point Positioning (PPP) Precise Positioning Engine (PPE), according to an embodiment.

FIG. 3 is a block diagram illustrating an example Real Time Kinematic (RTK) positioning scheme, according to aspects of the disclosure.

FIG. 4 is an illustration of a table showing the various data fields of state space representation (SSR) data, according to some embodiments.

FIG. 5A is a block diagram illustrating an example spatial server-based state space representation (SSR) service enhancement scheme, according to some embodiments.

FIG. 5B is an example fitted plot for the measurement residuals for determining updated GNSS error correction data, according to some embodiments.

FIG. 6 is a block diagram illustrating an example temporal server-based SSR service enhancement scheme, according to some embodiments.

FIG. 7 is a flow diagram illustrating an example method updating GNSS error correction data for GNSS-based positioning, according to aspects of the disclosure.

FIG. 8 is a block diagram of an embodiment of a GNSS device.

FIG. 9 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described concerning the accompanying drawings, which form a part hereof. While particular examples in which one or more aspects of the disclosure may be implemented are described below, other examples may be used, and various modifications may be made, without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “GNSS device,” “mobile device,” and “User Equipment” (UE) may be used interchangeably and are not intended to be specific or otherwise limited to any particular Radio Access Technology (RAT), unless otherwise noted. In general, a GNSS device, a mobile device, and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a GNSS device, a mobile device, and/or UE may be used to communicate over a wireless communications network. A UE may be mobile or may (e.g., at certain times) be stationary, and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally. UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV) as referred to herein, relates to an object that is capable of transmitting signals to receivers on the earth's surface. In one particular example, such an SV may comprise a geostationary satellite. Alternatively, an SV may comprise a satellite traveling in an orbit and moving relative to a stationary position on the Earth. However, these are merely examples of SVs, and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

As previously noted, GNSS-based positioning techniques such as Precise Point Positioning (PPP) and Real Time Kinematic (RTK) can provide high precision-sometimes centimeter-level accuracy. To provide such high-precision positioning at a target GNSS device, such techniques apply error correction to GNSS measurements performed at the device. Observation-space representation (OSR) and State space representation (SSR) are two formats in which such error correction may be communicated. OSR includes a “lump sum” of error components (e.g., pseudo-range, carrier phase, Doppler, and CN0 from multiple GNSS constellations, signals, SVs) represented in observation space and is used primarily in conventional RTK/PPP products. On the other hand, SSR includes up to eight elements of error correction. This format can provide higher error correction accuracy than OSR and is widely used in recent RTK/PPP products to enhance positioning performance.

However, the accuracy of SSR may not always meet the required standards for GNSS. For instance, even after applying International GNSS Service (IGS) SSR orbit/clock corrections, GNSS satellite errors of up to 50 cm can still persist. Additionally, when it comes to region-specific SSR data, such as ionospheric delay (also known as “iono.” SSR5) and tropospheric delay (“tropo,” SSR6), larger residuals may be present. These can be attributed to several factors including an insufficiently dense SSR generation network, a less than optimal SSR data rate, latency in SSR data under highly dynamic atmospheric conditions, and outages in SSR data traffic. Consequently, these issues can result in precision positioning performance that falls short of expectations, especially when a sub-meter level positioning accuracy or instantaneous RTK/PPP fixed solutions are required.

Various aspects relate generally to updating existing GNSS error correction data (e.g., SSR data and/or OSR data) to help enable high-accuracy positioning of a device using techniques such as PPP or RTK. Some aspects more specifically relate to using multiple GNSS measurements crowdsourced from one or more GNSS devices across a plurality of measurement epochs (e.g., crowdsourced qualified client data) to update the existing GNSS error correction data. In some embodiments, in response to the multiple GNSS measurements being performed by a plurality of GNSS devices, the updated GNSS error correction data may be broadcast to GNSS devices according to a zoning of the multiple GNSS measurements. Additionally or alternatively, if the multiple GNSS measurements are performed by a same GNSS device (e.g., including previous GNSS measurements and/or a multipath heatmap), the updated GNSS error correction data may be transmitted to the GNSS device performing the GNSS measurements where at least a portion of the updated GNSS error correction data expires after a predetermined period of time.

By aggregating data—such as multiple GNSS measurements crowdsourced from one or more GNSS devices across a plurality of measurement epochs—and utilizing larger system resources at a computer system (e.g., a server hosted in the cloud and connected to the satellite), the accuracy of the GNSS error correction data can be enhanced, thereby helping ensure the precision positioning performance meets expectations.

Embodiments for updating the existing GNSS error correction data are provided in detail hereafter, following a review of applicable technology.

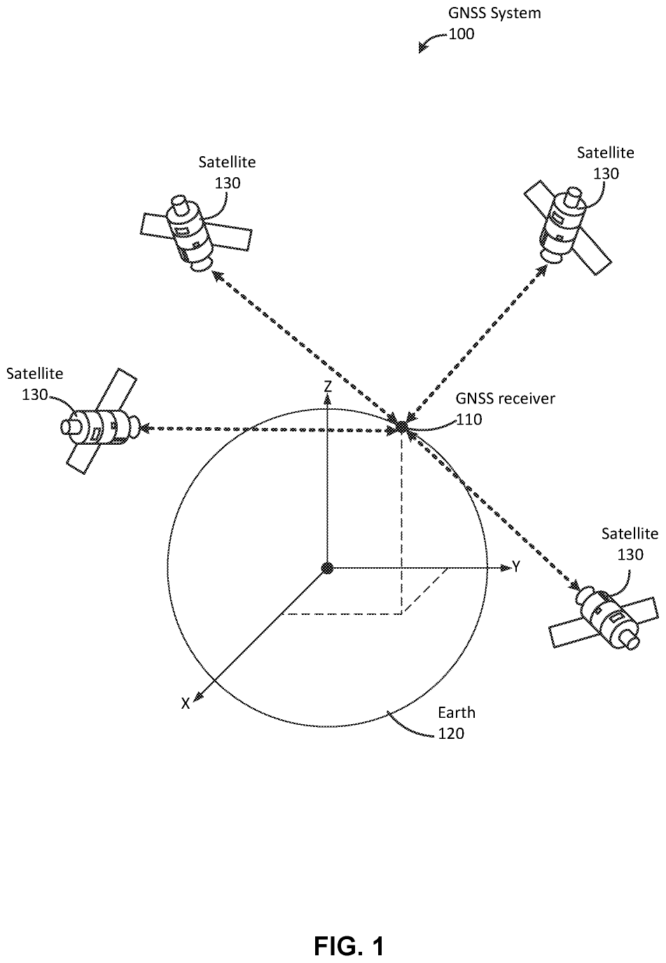

FIG. 1 is a simplified diagram of a GNSS system 100, provided to illustrate how GNSS is generally used to determine an accurate location of a GNSS receiver 110 on Earth 120. Put generally, the GNSS system 100 enables an accurate GNSS position fix of the GNSS receiver 110, which receives RF signals from GNSS satellites 130 (also known as GNSS “satellite vehicles” or “SVs”) from one or more GNSS constellations. The types of GNSS receiver 110 used may vary, depending on the application. In some embodiments, for instance, the GNSS receiver 110 may comprise a standalone device or component incorporated into another device. In some embodiments, the GNSS receiver 110 may be integrated into industrial or commercial equipment, such as survey equipment, Internet of Things (IoT) devices, etc.

It will be understood that the diagram provided in FIG. 1 is greatly simplified. In practice, there may be dozens of satellites 130 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when an RF signal is transmitted from the respective satellite 130 to when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, and is subject to many of the previously described errors. Even so, code-based GNSS positioning can provide a positioning accuracy for the GNSS receiver 110 on the order of meters.

More accurate carrier-based ranging is based on a carrier wave of the RF signals received from each satellite and further uses error correction to help reduce errors from the previously noted error sources. Carrier-based positioning measurements for positioning in this manner may be referred to as carrier phase (or CP) measurements. Some techniques utilize differential error correction, in which errors (e.g., atmospheric errors sources) in the carrier-based ranging of satellites 130 observed by the GNSS receiver 110 can be mitigated or canceled based on similar carrier-based ranging of the satellites 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudo ranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 1, the satellites 130 may be members of a single satellite constellation, i.e., a group of satellites that are part of a GNSS system, e.g., controlled by a common entity such as a government, and orbiting in complementary orbits to facilitate determining positions of entities around the world. One or more of the satellites 130 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

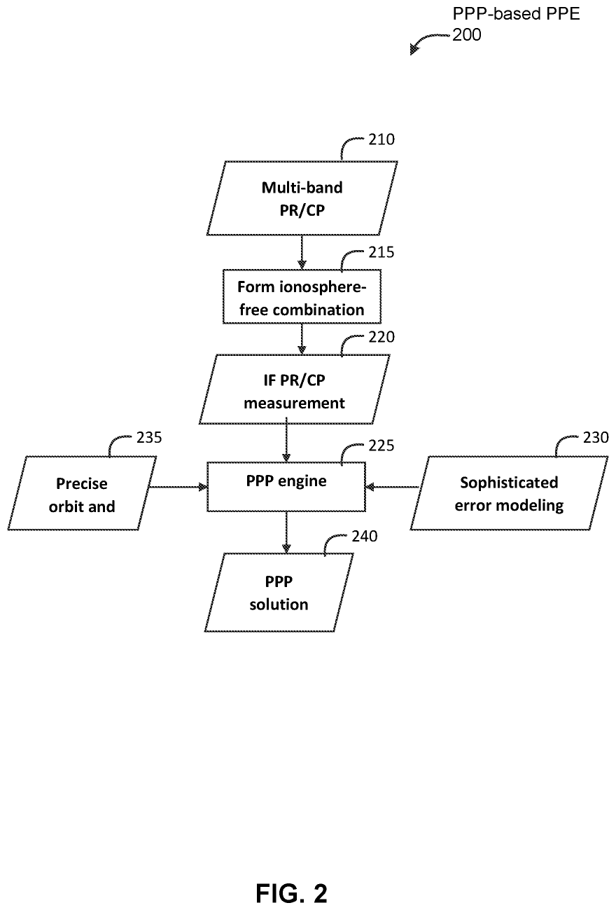

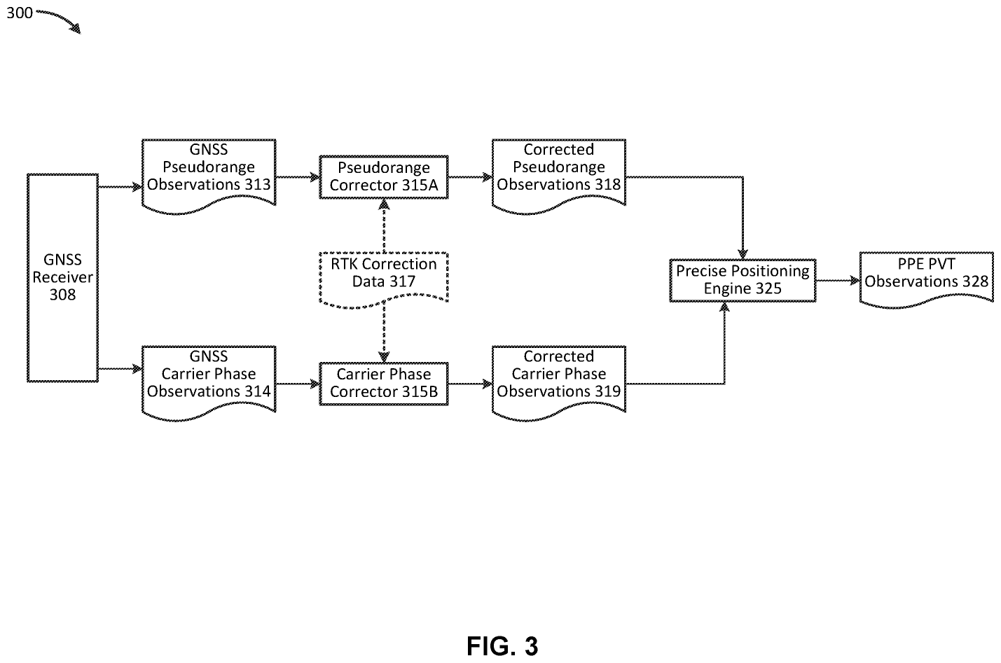

As previously noted, high-accuracy, or “precise,” GNSS-based positioning (e.g., PPP or RTK positioning) utilize error correction provided by an error correction service. FIGS. 2 and 3 generally illustrate how such correction may be utilized in PPP and RTK.

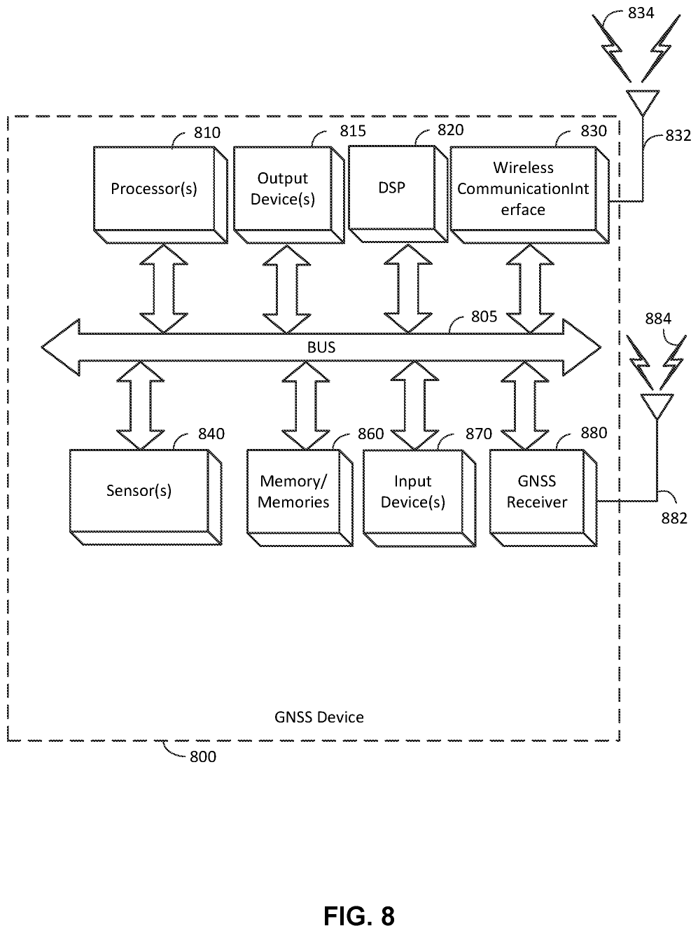

FIG. 2 is a block diagram of a PPP-based PPE 200, which may be used to determine an accurate PPP-based position. The blocks in FIG. 2 comprise data and logical processes used by a PPE to perform PPP-based positioning of a GNSS receiver (e.g., the GNSS receiver 110 of FIG. 1). In some embodiments, the various blocks in FIG. 2 may be implemented by software and/or hardware components of a positioning engine, which may be integrated into the mobile device for which positioning is determined. (Example components of a mobile device are shown in FIG. 8, which is described in detail hereafter.).

At block 210, the GNSS receiver obtains multi-band pseudo-range (PR) and carrier phase (CP) measurement of signals from each of the plurality of satellites (e.g., satellites 130 of FIG. 1). PR and CP measurements may correspond with code-based and carrier-based measurements, respectively, as previously described. To make a multi-band measurement (a measurement of signals using two or more frequencies transmitted by a satellite), embodiments may use a multi-band GNSS receiver (e.g., a dual-band receiver, tri-band receiver, etc.) capable of receiving a plurality of frequency bands. Some embodiments may use multi-constellation multi-frequency (MCMF) receivers capable of receiving multiple frequency bands on multiple constellations. Examples of different bands used for the multi-band PR/CP measurement at block 210 include L1/L5 for GPS, E1/E5A for GAL, and B1C/B2A for BDS. Other embodiments may use additional or alternative bands and/or GPS constellations.

At block 215, an ionosphere-free (IF) combination is formed. An ionosphere-free combination comprises a linear combination of code and/or carrier measurements that can eliminate first-order ionospheric effects from ionospheric refraction, which can increase the accuracy of the positioning solution. As shown by block 220, the ionosphere-free (IF) PR/CP measurement formed from the IF combination is provided to the PPP engine 225.

The sophisticated error modeling at block 230 comprises error modeling to mitigate inaccuracies based on various error sources. Standard PPP error mitigation includes error reduction techniques to reduce satellite different code bias (DCB), satellite phase windup-up, site displacement, and more. These errors may result in inaccuracies of several meters or more, and mitigation can be performed by a Kalman Filter (KF) (or Extended Kalman Filter (EKF)), which may estimate these errors/values.

The PPP engine 225 uses the IF PR/CP measurement (block 220), sophisticated error modeling (block 230), and precise orbit and clock (block 235) to conduct a KF estimation to provide the PPP solution at block 240. As a person of ordinary skill in the art will appreciate, a PPP engine can be implemented using an Extended Kalman Filter (EKF).

As noted, devices may utilize a PPE to provide high-precision positioning using PPP and/or RTK correction information. Both PPP and RTK have benefits and drawbacks. For RTK, which derives correction information from differential GNSS readings between a target device (or “rover station”) and one or more local base stations, benefits include simple error modeling computation and better performance on error canceling. The drawbacks of RTK, however, include the need for local or regional reference stations and a larger bandwidth requirement (relative to PPP). For PPP, which involves providing precise orbit/clock information to a target device (and optional ionosphere and troposphere correction for additional enhancement), benefits include a low bandwidth requirement (relative to RTK) and global coverage. Drawbacks of PPP include the need for complex error modeling computation.

FIG. 3 is a block diagram illustrating an example RTK positioning scheme 300, according to aspects of the disclosure. In some embodiments, the various blocks may be implemented by software and/or hardware components of a positioning engine, which may be integrated into the mobile device for which positioning is determined. (Example components of a mobile device are shown in FIG. 8, which is described in detail hereafter.)

According to positioning scheme 300, a GNSS receiver 308 measures GNSS signals to obtain GNSS pseudorange observations 313 and GNSS carrier phase observations 314. In various examples, the GNSS receiver 308 may correspond to GNSS receiver 110 of FIG. 1 and/or may be incorporated into a mobile or other device (e.g., a mobile device as described herein). Based on RTK correction data 317, a pseudorange corrector 315A corrects GNSS pseudorange observations 313 to obtain corrected pseudorange observations 318, and a carrier phase corrector 315B corrects GNSS carrier phase observations 314 to obtain corrected carrier phase observations 319. In various examples, the RTK correction data 317 may be representative of correction data provided by a correction service (e.g., RTK correction service). Based on corrected pseudorange observations 318 and corrected carrier phase observations 319, a precise positioning engine (PPE) 325 generates PPE position, velocity, and time (PVT) observations 328.

As noted with respect to FIGS. 2 and 3, high-precision PPE position determination (e.g., using PPP and/or RTK) for a GNSS device typically utilizes error correction received from a remote device (e.g., error correction service). Although PPP products may use state-space representation (SSR) format for error correction, conventionally, most PPE or RTK products use error correction in observation-space representation (OSR) format. OSR format provides a “lump sum” of error components that are represented in observation space. These components may include pseudorange, carrier phase, Doppler, and CN0 from multiple GNSS constellations, signals, satellites (SVs).

That said, more and more modern products are starting to accept or offer error correction in SSR format. This is because SSR format has several advantages, including utilizing a smaller communication bandwidth (less traffic), having a scalable frequency operation (no frequency dependency), being included in many standards evolutions (Radio Technical Commission for Maritime Services (RTCM), 3rd Generation Partnership Project (3GPP), international GNSS service (IGS)), and a portion of SSR data (orbit, clock, code bias) are available to the public, such as international GNSS service IGS SSR, BDS (Beudou) B2b (or B2b-PPP) correction.

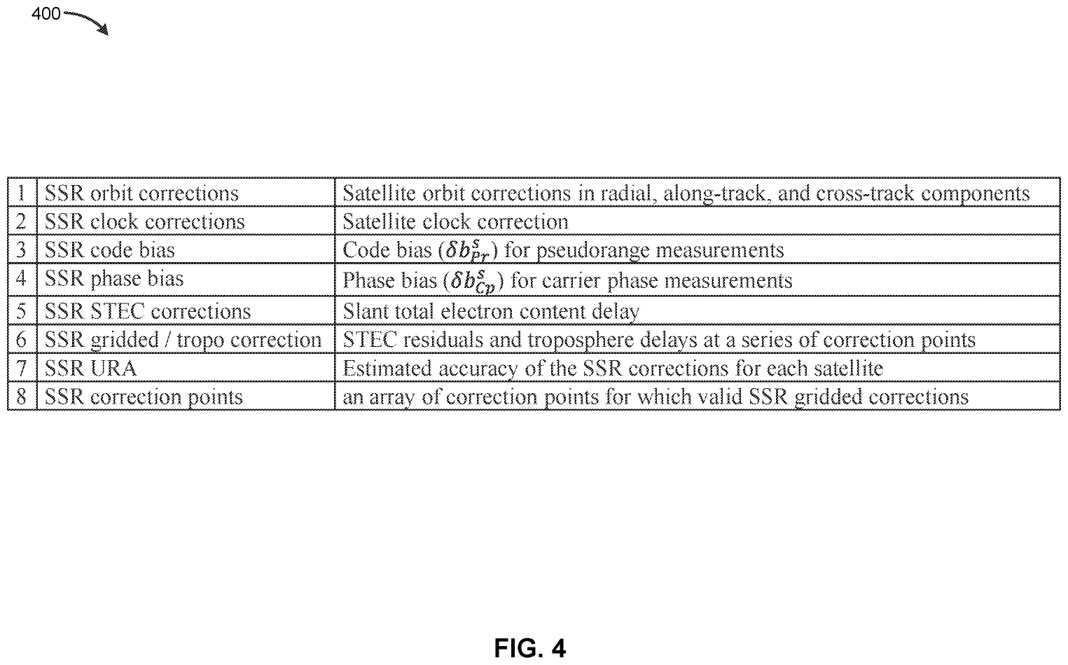

FIG. 4 is an illustration of Table 400, showing the various data fields of SSR data, according to some embodiments. Specifically, SSR data may include eight types of data, which may be referred to herein by “SSR” followed by the responded numeral in the first column of Table 400. Thus, SSR1 comprises satellite orbit corrections, SSR2 comprises deadline clock corrections, SSR3 comprises code bias (e.g., differential code bias (DCB)), SSR4 comprises phase bias, SSR5 comprises slants total electron content (STEC) delay correction (e.g., ionosphere delay correction), SSR6 (which may be referred to herein generally as tropospheric delay correction) comprises STEC residuals and tropospheric delays, SSR7 comprises an estimated accuracy value (e.g., user range accuracy (URA)) of other SSR data (e.g., SSR1-SSR6), and SSR8 comprises correction points for which valid SSR gridded corrections are applicable. In error correction, SSR may be provided as a vector with one or more of the data fields shown in Table 400, where each element of the vector represents a different data field.

As stated above, to provide such high-precision positioning at a target GNSS device, techniques such as PPP and RTK apply error correction to GNSS measurements performed at the device. Existing GNSS error correction data such as SSR data and OSR data may not always meet the required standards for GNSS. For instance, even after applying IGS SSR orbit/clock corrections, GNSS satellite errors of up to 50 cm can still persist.

Embodiments herein address these and other issues by using multiple GNSS measurements from one or more GNSS devices (e.g., crowdsourced qualified client data) across a plurality of measurement epochs (e.g., including previous client data and/or a multipath heatmap) to update the existing GNSS error correction data. Additionally, a computer system, such as a server, can be utilized.

These systems typically have more resources compared to a GNSS device that uses existing PPP and RTK techniques, allowing for more comprehensive processing of the multiple GNSS measurements alongside existing GNSS error correction data (e.g., SSR data and/or OSR data). For example, the process could include processing the multiple GNSS measurements in batch mode, whereby the data may be processed in both backward and forward fashions. As such, the embodiments disclosed herein can establish more precise location estimates for the one or more GNSS devices which in turn can subsequently be used to refine and update the existing GNSS error correction data.

The updated GNSS error correction data may then be transmitted to beneficiary GNSS device(s) and be used for enhancing the positioning performance of RTK/PPP service(s) (e.g., for offering higher positioning accuracy and/or instantaneous RTK fix). In some embodiments, in response to the multiple GNSS measurements being performed by a plurality of GNSS devices (e.g., a spatial server-based SSR service enhancement scheme), the updated GNSS error correction data may be broadcast to GNSS devices according to a zoning of the multiple GNSS measurements. Additionally or alternatively, if the multiple GNSS measurements (e.g., including previous GNSS measurements and/or a multipath heatmap) are performed by a same GNSS device (e.g., a temporal server-based SSR service enhancement scheme), the updated GNSS error correction data may be transmitted to the GNSS device performing the GNSS measurements. By aggregating data—such as multiple GNSS measurements crowdsourced from one or more GNSS devices across a plurality of measurement epochs—and utilizing larger system resources at a computer system (for example, a server), the accuracy of the GNSS error correction data can be enhanced, thereby ensuring the precision GNSS positioning performance meets expectations. It is understood that the GNSS devices from which the multiple GNSS measurements are crowdsourced may not be of the same make/model. The GNSS devices can span multiple original equipment manufacturer make/models and/or device types.

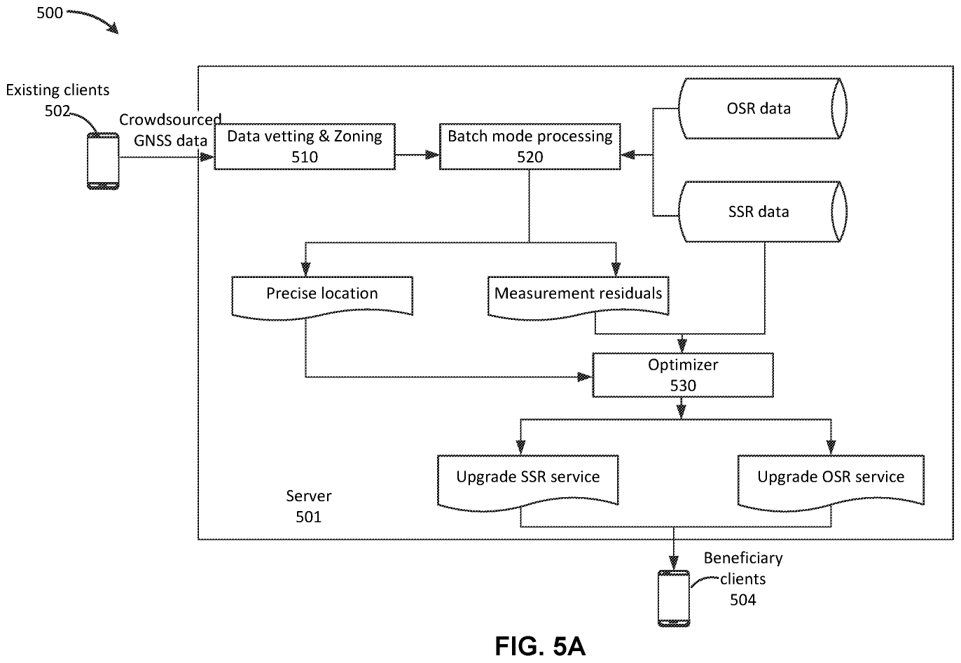

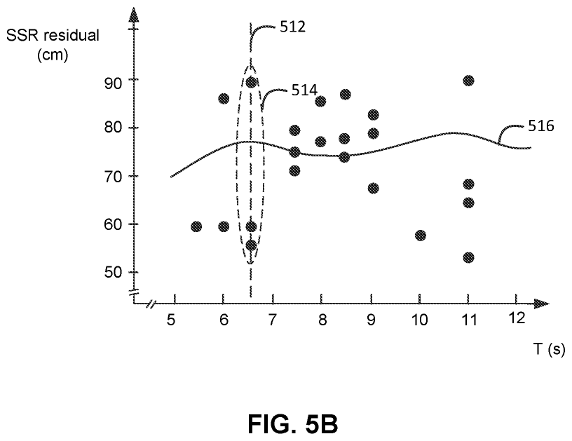

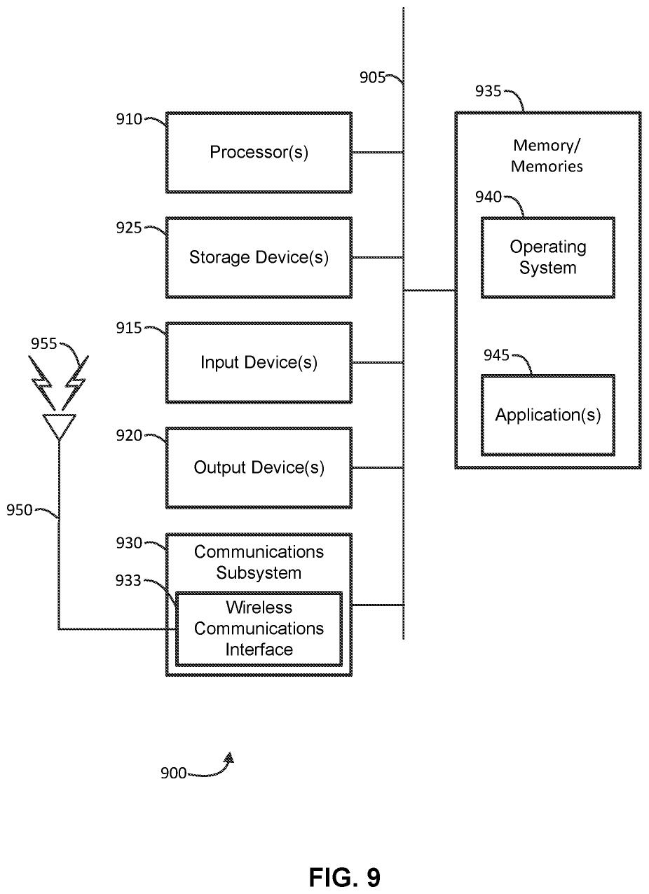

FIG. 5A is a block diagram illustrating an example spatial server-based SSR service enhancement scheme 500, according to some embodiments. Spatial server-based SSR service enhancement scheme 500 may be performed by a server 501. In some embodiments, server 501 may be connected to satellites (e.g., satellite 130 in FIG. 1) and may include a computer server hosted in the cloud by a service. In some embodiments, the various blocks shown in FIG. 5A may be implemented by software and/or hardware components of a computer system. Example components of a computer system are shown in FIG. 9, which is described in detail hereafter.

In some embodiments, according to spatial server-based SSR service enhancement scheme 500, crowdsourced GNSS data (e.g., qualified data) may be obtained from existing clients 502 (e.g., qualified GNSS devices) and used for updating existing GNSS error correction data. The updated output GNSS error correction data may be communicated to beneficiary clients 504 for enhancing the positioning performance. In some embodiments, existing clients 502 and beneficiary clients 504 may include a plurality of GNSS devices (e.g., including a mobile device, base station, or other device comprising and/or communicatively coupled with a GNSS receiver) that may be capable of using PPP and/or RTK for GNSS positioning. Example components of a GNSS device are shown in FIG. 8, which is described in detail hereafter.

For example, the qualified client data may be from qualified (classified and checked) GNSS devices. In some embodiments, the qualified GNSS devices may include mobile devices and/or devices associated with vehicles (e.g., GNSS devices with automotive grade antennas). Moreover, the specification of the qualified GNSS devices may need to meet certain requirements (e.g., RTK/PPP requirements). For example, the RTK/PPP requirements of the qualified GNSS devices may include: (1) The types of measurements the qualified GNSS devices support. For instance, the qualified GNSS devices may need to support at least the pseudorange measurements and the carrier phase measurements. Supporting Doppler measurements could be optional. (2) The capability of the GNSS devices to process multiple frequencies, which may be necessary for iono error estimation. (3) A measurement sampling rate that is not lower than a predetermined rate (e.g., once every 30 seconds). (4) The GNSS carrier phase measurements that are continuously tracked (e.g., to maintain carrier phase integer ambiguity).

Starting at block 510, the crowdsourced GNSS data (qualified client data/the multiple GNSS measurements) may go through vetting and zoning processes. In some embodiments, during the vetting process, server 501 may filter out low-quality GNSS measurements/data in the multiple GNSS measurements and/or low-quality devices from the crowdsourcing. For example, low-quality GNSS measurements may be filtered based on carrier-to-noise density ratio of the multiple GNSS measurements, carrier phase cycle slips of the multiple GNSS measurements, or any combination thereof. Specifically, low-quality data/devices may include (1) any device that do not meet the requirements stated above for determining the qualified GNSS devices, (2) measurements with a CN0 value below 20 dBHz, (3) carrier phase measurements that are not continuous or contains cycle slip, and/or (4) GNSS devices located in GNSS-denied environments with limited measurements (e.g., the measurements have low quality, such as poor satellite geometry and/or a very low number of visible satellites, such as fewer than 3 or 4.

In some embodiments, during the zoning process, server 501 may perform an initial positioning of the multiple GNSS measurements for determining a coarse position estimate of where the GNSS measurements are performed (e.g., existing clients 502). For example, the initial positioning may be performed based on one or more pre-defined SSR grids (e.g., a grid having a 10 km by 10 km grid size, used in 3GPP format iono and tropo correction data). The GNSS measurements may be categorized into zones/regions according to the coarse position estimates.

At block 520, after being validated and categorized into zones, the GNSS measurements may be corrected using existing GNSS error correction data (such as SSR and/or OSR data) and be processed in batch mode for PPE (e.g., using PPP and/or RTK). Precise location estimates of the multiple GNSS devices and GNSS measurement residuals may be determined as a result. For instance, when determining the precise location estimates, multiple GNSS measurements—obtained from multiple GNSS devices across multiple measurement epochs—can be processed concurrently, e.g., using both backward and forward methods, along with being corrected using the existing GNSS error correction data. Compared with the existing positioning schemes where high-precision positioning is normally performed by the GNSS device based on processing the GNSS measurements sequentially, the batch mode performed by server 501 may provide enhanced positioning performance and accuracy. Furthermore, measurement residuals can be determined based on the precise location estimates of multiple GNSS devices.

It is contemplated that although as shown in FIG. 5A, the SSR data and the OSR data are stored on server 501, other implementations may also be applied in accordance with specific requirements. For example, a portion of or all of the SSR data and/or the OSR data may be stored on an entity separate from server 501 and may be obtained by server 501 using any suitable data communication methods.

At block 530, updated GNSS error correction data may be determined/estimated based on 1. the measurement residuals and 2. the existing error correction data using, e.g., an optimizer. Moreover, the updated GNSS error correction data may further be determined/estimated based on the precise location estimates. For example, as shown in FIG. 5B, measurement residuals for different GNSS measurements may be determined according to the precise location estimates. In some embodiments, multiple measurement residuals may be generated on a same epoch from GNSS measurements performed by multiple GNSS devices. As a nonlimiting example, as shown in FIG. 5B, at epoch 512, measurement residuals 514 are generated from GNSS measurements performed by three GNSS devices. By fitting, e.g., using a weighted average or median of those measurement residuals (e.g., fitting to line 516), updated/more accurate GNSS error correction data may be determined. It is contemplated that any suitable fitting mechanisms, such as linear regression, polynomial regression, least squares fitting, etc., may be used.

In some embodiments, if the existing GNSS error correction data includes SSR data, the updated residuals may be decoupled into individual SSR corrections components (e.g., one or more of SSR1-SSR8 as discussed above) to obtain a more accurate SSR data update. Furthermore, the process of zoning the multiple GNSS measurements could further improve the accuracy of the updated SSR data, especially when considering the regional aspect of the SSR data, such as ionospheric delay (“iono,” SSR5) and tropospheric delay (“tropo,” SSR6).

By utilizing GNSS measurements from a large number of different GNSS devices, the updating scheme disclosed herein may also negate the inaccuracies or errors in the updated GNSS error correction data, which are often introduced by the multipath effect.

Referring back to FIG. 5A, the SSR and/or OSR service may be upgraded based on the updated GNSS error correction data, thereby providing more accurate error correction for GNSS positioning. For instance, the updated GNSS correction data may be broadcasted to beneficiary clients 504, with the zoning of the multiple GNSS measurements being considered. This updated GNSS error correction data could enhance the positioning performance of the GNSS devices by offering higher positioning accuracy and instantaneous RTK fixes. Additionally, if the existing GNSS error correction data includes OSR data, e.g., in Virtual Reference Station (VRS) format, it could also correct inaccuracies in the VRS broadcast coordinates.

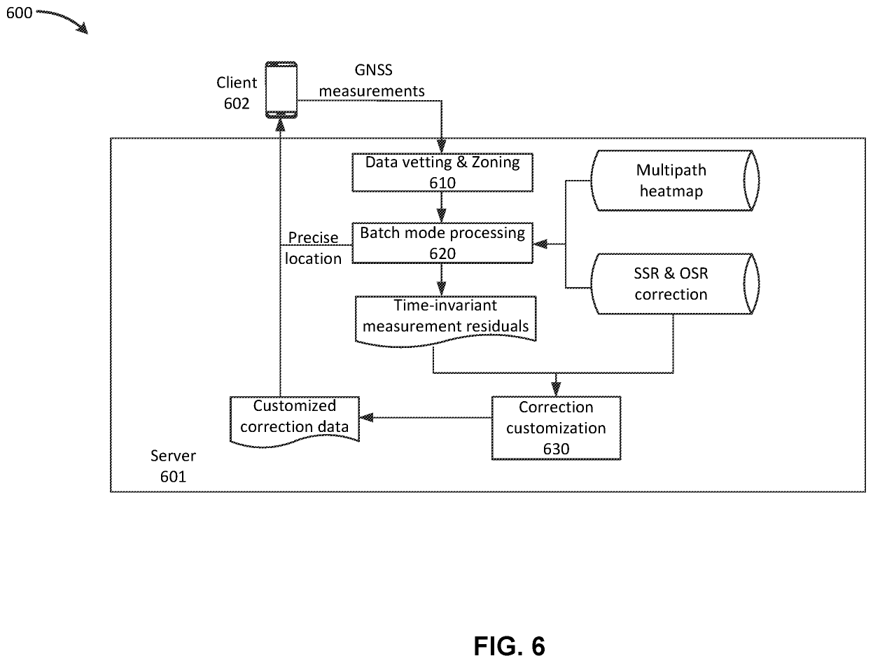

In some embodiments, the server-based SSR service enhancement scheme disclosed herein may also be applied to enhance a specific client's positioning performance (e.g., determining a customized version of GNSS error correction data using previous client data and/or empirical multipath heatmap). For example, FIG. 6 is a block diagram illustrating an example temporal server-based SSR service enhancement scheme 600, according to some embodiments. Similar to spatial server-based SSR service enhancement scheme 500, temporal server-based SSR service enhancement scheme 600 may be performed by a server 601. In some embodiments, server 601 may be connected to satellites (e.g., satellite 130 in FIG. 1) and may include a computer server hosted in the cloud by a service. In some embodiments, the various blocks shown in FIG. 6A may be implemented by software and/or hardware components of a computer system. Example components of a computer system are shown in FIG. 9, which is described in detail hereafter.

In some embodiments, according to temporal server-based SSR service enhancement scheme 600, previous GNSS data (e.g., GNSS measurements from the GNSS device across different epochs) and/or empirical multipath heatmap (e.g., as a function of location and time) may be obtained from client 602 and used for customizing/updating existing GNSS error correction data. The customized/updated output GNSS error correction data may be communicated to client 602 for enhancing the positioning performance. In some embodiments, client 602 may include a GNSS device that may be capable of using PPP and/or RTK for GNSS positioning. Example components of a GNSS device are shown in FIG. 8, which is described in detail hereafter.

Starting at block 610, previous GNSS data and/or empirical multipath heatmap may go through vetting and zoning processes, similar to block 510 in FIG. 5A.

At block 620, after being validated and categorized into zones, the GNSS measurements may be corrected using existing GNSS error correction data (such as SSR and/or OSR data) and be processed in batch mode for PPE (e.g., using PPP and/or RTK). Precise location estimates of the GNSS device, and time-invariant GNSS measurement residuals may be determined from the multiple epochs as a result. For instance, when determining the location estimates, more than one RTK engine may be used by server 601 and the location estimates may be determined based on a longer time frame (e.g., using the forward and backward methods and brutal search based on position grids and integer ambiguity resolution (IAR)).

At block 630, similar to block 530, updated GNSS error correction data may be determined/estimated based on 1. the location estimates, 2. the time-invariant GNSS measurement residuals, and 3. the existing error correction data and/or multipath heatmap (e.g., provided for enhancing the SSR in complicated GNSS environment). Different from spatial server-based SSR service enhancement scheme 500, updated GNSS error correction data (e.g., specified for client 602) may be customized based on the time-invariant GNSS measurement residuals. In some embodiments, the customized GNSS error correction data may also include additional residual correction accounting for the multipath effect). Based on the updated/customized GNSS error correction data, a more precise location estimate of client 602 may subsequently be determined.

Accordingly, the more precise location estimates and the customized GNSS error correction data may be transmitted to client 602 where at least a portion of the updated/customized GNSS error correction data expires after a predetermined period of time.

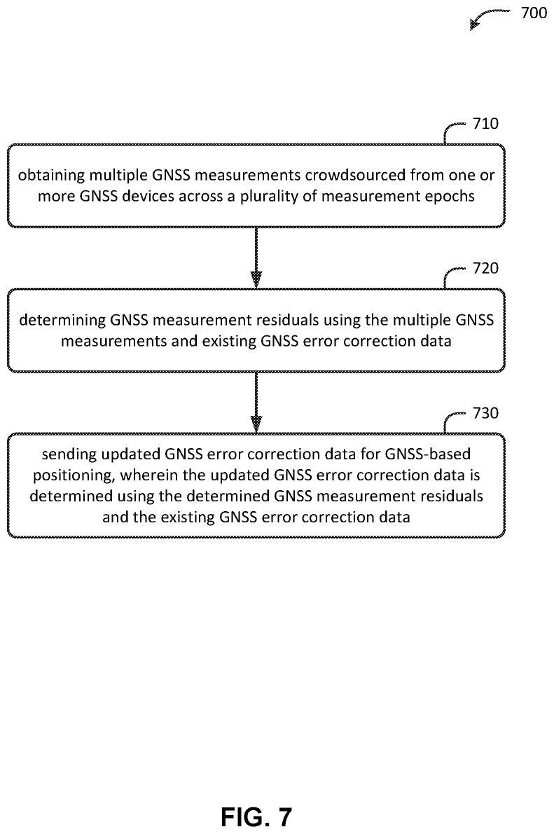

FIG. 7 is a flow diagram illustrating an example method updating error correction data for GNSS-based positioning, according to aspects of the disclosure. According to aspects of the disclosure, means for performing the functionality illustrated in one or more of the blocks shown in FIG. 7 may be performed by hardware and/or software components of a server (e.g., server 501 in FIG. 5 and/or server 601 in FIG. 6). Example components of a computer system that could operate as a computer system are illustrated in FIG. 9, which is described in more detail below.

At block 710, the functionality comprises obtaining multiple GNSS measurements crowdsourced from one or more GNSS devices across a plurality of measurement epochs. In some embodiments, as discussed with respect to FIGS. 5A and 5B, in a spatial server-based SSR service enhancement scheme, the multiple GNSS measurements may be obtained from a plurality of GNSS devices. Additionally or alternatively, as discussed with respect to FIG. 6, in a temporal server-based SSR service enhancement scheme, the multiple GNSS measurements may be obtained from a same GNSS device.

Means for performing functionality at block 710 may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

At block 720, the functionality comprises determining GNSS measurement residuals using the multiple GNSS measurements and existing error correction data. As noted, the multiple GNSS measurements (e.g., crowdsourced GNSS data in spatial server-based SSR service enhancement scheme, and previous GNSS data and/or empirical multipath heatmap in temporal server-based SSR service enhancement scheme) may go through vetting and zoning processes prior to determining GNSS measurement residuals. In some embodiments, during the vetting process, the server may filter out low-quality GNSS measurements in the multiple GNSS measurements. For example, low-quality GNSS measurements may be filtered based on carrier-to-noise density ratio of the multiple GNSS measurements, carrier phase cycle slips of the multiple GNSS measurements, or any combination thereof. In some embodiments, during the zoning process, the server may perform an initial positioning of the multiple GNSS measurements for determining a coarse position estimate of where the GNSS measurements are performed (e.g., the one or more GNSS devices). As noted, the initial positioning may be performed based on one or more pre-defined SSR grids (e.g., a grid having a 10 km by 10 km grid size). The GNSS measurements may be categorized into zones/regions according to the coarse position estimates.

After being validated and categorized into zones, the GNSS measurements may be corrected using existing GNSS error correction data (such as SSR and/or OSR data) and be processed in batch mode for PPE (e.g., using PPP and/or RTK). Precise location estimates of the multiple GNSS devices and GNSS measurement residuals may be determined as a result. For instance, when determining the precise location estimates, multiple GNSS measurements—obtained from the one or more GNSS devices across a plurality of measurement epochs—can be processed concurrently, e.g., using both backward and forward methods, along with being corrected using the existing GNSS error correction data. Compared with the existing positioning schemes where high-precision positioning is normally performed by the GNSS device based on processing the GNSS measurements sequentially, the batch mode performed by the server may provide enhanced positioning performance and accuracy. Furthermore, measurement residuals can be determined based on the precise location estimates of the one or more GNSS devices across a plurality of measurement epochs.

Accordingly, updated (and/or customized in temporal server-based SSR service enhancement scheme) GNSS error correction data may be determined/estimated based on 1. the measurement residuals, and 2. the existing error correction data using e.g., an optimizer, and may be further determined/estimated based on the precise location estimates, as discussed with respect to FIG. 5A and/or correction customization as discussed with respect to FIG. 6.

In some embodiments, the existing GNSS error correction data may include SSR data and/or OSR data. If the existing GNSS error correction data includes SSR data, the updated residuals may be decoupled into individual SSR corrections components (e.g., one or more of SSR1-SSR8 as discussed above) to obtain a more accurate SSR data update.

Means for performing functionality at block 720 may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

At block 730, the functionality comprises sending updated error correction data for GNSS-based positioning, wherein the updated error correction data is determined using the determined GNSS measurement residuals and the existing error correction data. For instance, in spatial server-based SSR service enhancement scheme, the updated GNSS correction data may be broadcasted to the beneficiary clients with the zoning of the multiple GNSS measurements being considered (e.g., broadcast to nearby GNSS devices considering the regional aspect of the SSR data, such as ionospheric delay (“iono,” SSR5) and tropospheric delay (“tropo,” SSR6)). This updated GNSS error correction data could enhance the positioning performance of the GNSS devices by offering higher positioning accuracy and instantaneous RTK fixes. Additionally, if the existing GNSS error correction data includes OSR data, e.g., in Virtual Reference Station (VRS) format, it could also correct inaccuracies in the VRS broadcast coordinates. In temporal server-based SSR service enhancement scheme, the more precise location estimates and the customized GNSS error correction data may be transmitted to the client (the GNSS device) where at least a portion of the updated GNSS error correction data expires after a predetermined period of time.

Means for performing functionality at block 730 may comprise a bus 905, processor(s) 910, communications subsystem 930 (which may include wireless communications interface 933), memory/memories 935, operating system 940, application(s) 945, and/or other components of a computer system 900 as illustrated in FIG. 9, for example.

FIG. 8 is a block diagram of an embodiment of a GNSS device 800, which can be utilized as described herein above (e.g., in association with FIGS. 1-7). For example, the GNSS device 800 can be used to implement one or incorporate the GNSS receiver 110 of FIG. 1. PPP-based PPE 200 of FIG. 2, RTK positioning scheme 300 of FIG. 3, existing clients 502 and/or beneficiary clients 504 of FIG. 5A, client 602 of FIG. 6, and the like. It should be noted that FIG. 8 is meant only to provide a generalized illustration of various components, any or all of which may be utilized as appropriate.

The GNSS device 800 is shown comprising hardware elements that can be electrically coupled via a bus 805 (or may otherwise be in communication, as appropriate). The hardware elements may include a processor(s) 810 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 810 may comprise one or more processing units, which may be housed in a single integrated circuit (IC) or multiple ICs. As shown in FIG. 8, some embodiments may have a separate DSP 820, depending on desired functionality. Location determination and/or other determinations based on wireless communication may be provided in the processor(s) 810 and/or wireless communication interface 830 (discussed below). The GNSS device 800 also can include one or more input devices 870, which can include without limitation one or more keyboards, touch screens, touch pads, microphones, buttons, dials, switches, and/or the like; and one or more output devices 815, which can include without limitation one or more displays (e.g., touch screens), light emitting diodes (LEDs), speakers, and/or the like.

The GNSS device 800 may also include a wireless communication interface 830, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 800 to communicate with other devices as described in the embodiments above. The wireless communication interface 830 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 832 that send and/or receive wireless signals 834. According to some embodiments, the wireless communication antenna(s) 832 may comprise a plurality of discrete antennas, antenna arrays, or any combination thereof. The antenna(s) 832 may be capable of transmitting and receiving wireless signals using beams (e.g., Tx beams and Rx beams). Beam formation may be performed using digital and/or analog beam formation techniques, with respective digital and/or analog circuitry. The wireless communication interface 830 may include such circuitry.

Depending on desired functionality, the wireless communication interface 830 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 800 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 800 can further include sensor(s) 840. Sensor(s) 840 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 800 may also include a Global Navigation Satellite System (GNSS) receiver 880 capable of receiving signals 884 from one or more GNSS satellites using an antenna 882 (which could be the same as antenna 832). Positioning based on GNSS signal measurement can be utilized to complement and/or incorporate the techniques described herein. The GNSS receiver 880 can extract a position of the GNSS device 800, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS), and/or the like. Moreover, the GNSS receiver 880 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 880 is illustrated in FIG. 8 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 810, DSP 820, and/or a processor within the wireless communication interface 830 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 810 or DSP 820.

The GNSS device 800 may further include and/or be in communication with a memory 860. The memory 860 can include, without limitation, local and/or network accessible storage, a disk drive, a drive array, an optical storage device, a solid-state storage device, such as a random-access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 860 of the GNSS device 800 also can comprise software elements (not shown in FIG. 8), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 860 that are executable by the GNSS device 800 (and/or processor(s) 810 or DSP 820 within GNSS device 800). In some embodiments, then, such code and/or instructions can be used to configure and/or adapt a general-purpose computer (or other device) to perform one or more operations in accordance with the described methods.

FIG. 9 is a block diagram of an embodiment of a computer system 900, which may be used, in whole or in part, to provide the functions of one or more components and/or devices as described in the embodiments herein, including a server and/or services in the cloud. Thus, the computer system 900 may be utilized as and/or correspond with, for example, server 501 in FIG. 5, server 601 in FIG. 6, and/or a cloud, server, and/or remote device, or any combination thereof, as described herein. The computer system 900 may perform one or more of the operations of method 700 illustrated in FIG. 7. The computer system 900 may include, for example, a computer server, personal computer, personal electronic device, or the like. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner. In addition, it can be noted that components illustrated by FIG. 9 can be localized to a single device and/or distributed among various networked devices, which may be disposed at different geographical locations.

The computer system 900 is shown comprising hardware elements that can be electrically coupled via a bus 905 (or may otherwise be in communication, as appropriate). The hardware elements may include processor(s) 910, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 900 also may comprise one or more input devices 915, which may comprise without limitation a mouse, a keyboard, a camera, a microphone, and/or the like; and one or more output devices 920, which may comprise without limitation a display device, a printer, and/or the like.

The computer system 900 may further include (and/or be in communication with) one or more non-transitory storage devices 925, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 900 may also include a communications subsystem 930, which may comprise wireless communication technologies managed and controlled by a wireless communication interface 933, as well as wired technologies (such as Ethernet, coaxial communications, universal serial bus (USB), and the like). The wireless communication interface 933 may comprise one or more wireless transceivers that may send and receive wireless signals 955 (e.g., signals according to 5G NR or LTE) via wireless antenna(s) 950. Thus the communications subsystem 930 may comprise a modem, a network card (wireless or wired), an infrared communication device, a wireless communication device, and/or a chipset, and/or the like, which may enable the computer system 900 to communicate on any or all of the communication networks described herein to any device on the respective network, including a User Equipment (UE), base stations and/or other transmission reception points (TRPs), and/or any other electronic devices described herein. Hence, the communications subsystem 930 may be used to receive and send data as described in the embodiments herein.

In many embodiments, the computer system 900 will further comprise a working memory 935, which may comprise a RAM or ROM device, as described above. Software elements, shown as being located within the working memory 935, may comprise an operating system 940, device drivers, executable libraries, and/or other code, such as one or more applications 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general-purpose computer (or other device) to perform one or more operations in accordance with the described methods.

A set of these instructions and/or code might be stored on a non-transitory computer-readable storage medium, such as the storage device(s) 925 described above. In some cases, the storage medium might be incorporated within a computer system, such as computer system 900. In other embodiments, the storage medium might be separate from a computer system (e.g., a removable medium, such as an optical disc), and/or provided in an installation package, such that the storage medium can be used to program, configure, and/or adapt a general-purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. An example method for updating GNSS error correction data for global navigation satellite system (GNSS)-based positioning. The method performed by a server may comprise obtaining multiple GNSS measurements crowdsourced from one or more GNSS devices across a plurality of measurement epochs, determining GNSS measurement residuals using the multiple GNSS measurements and existing GNSS error correction data, and sending updated GNSS error correction data for GNSS-based positioning, wherein the updated GNSS error correction data is determined using the determined GNSS measurement residuals and the existing GNSS error correction data.
Clause 2. The method of clause 1, further comprising: prior to determining GNSS measurement residuals, filtering out low-quality GNSS measurements in the multiple GNSS measurements based on: carrier-to-noise density ratio of the multiple GNSS measurements; carrier phase cycle slips of the multiple GNSS measurements; or any combination thereof; and zoning the multiple GNSS measurements based on one or more pre-defined SSR grids.
Clause 3. The method of any of clause 1 or 2, wherein the multiple GNSS measurements are performed by a plurality of GNSS devices.
Clause 4. The method of any of clauses 1-3, wherein sending the updated GNSS error correction data comprises: broadcasting the updated GNSS error correction data according to the zoning.
Clause 5. The method of any of clause 1 or 2, wherein the multiple GNSS measurements are performed by a same GNSS device.
Clause 6. The method of any of clauses 1-5, wherein sending the updated GNSS error correction data comprises: transmitting the updated GNSS error correction data to the GNSS device, wherein at least a portion of the updated GNSS error correction data expires after a predetermined period of time.
Clause 7. The method of any of clauses 1-6, wherein determining the GNSS measurement residuals further comprises: determining a location of the one or more GNSS devices using the multiple GNSS measurements and the existing GNSS error correction data; and determining the GNSS measurement residuals using the location.
Clause 8. The method of any of clauses 1-7, wherein the existing GNSS error correction data comprises SSR data or OSR data.
Clause 9. The method of any of clauses 1-8, wherein the multiple GNSS measurements are processed in a backward fashion and a forward fashion.
Clause 10. An example server for updating GNSS error correction data for global navigation satellite system (GNSS)-based positioning comprises a transceiver, a memory, and one or more processors communicatively coupled with the transceiver and the memory. The one or more processors may be configured to obtain multiple GNSS measurements crowdsourced from one or more GNSS devices across a plurality of measurement epochs, determine GNSS measurement residuals using the multiple GNSS measurements and existing GNSS error correction data, and send updated GNSS error correction data for GNSS-based positioning, wherein the updated GNSS error correction data is determined using the determined GNSS measurement residuals and the existing GNSS error correction data.
Clause 11. The server of clause 10, wherein the one or more processors are further configured to: prior to determining GNSS measurement residuals, filter out low-quality GNSS measurements in the multiple GNSS measurements based on: carrier-to-noise density ratio of the multiple GNSS measurements; carrier phase cycle slips of the multiple GNSS measurements; or any combination thereof; and zone the multiple GNSS measurements based on one or more pre-defined SSR grids.
Clause 12. The server of any of clause 10 or 11, wherein the multiple GNSS measurements are performed by a plurality of GNSS devices.
Clause 13. The server of any of clauses 10-12, wherein to send the updated GNSS error correction data, the one or more processors are further configured to: broadcast the updated GNSS error correction data according to the zoning.
Clause 14. The server of any of clause 10 or 11, wherein the multiple GNSS measurements are performed by a same GNSS device.
Clause 15. The server of any of clauses 10-14, wherein to send the updated GNSS error correction data, the one or more processors are further configured to: transmit the updated GNSS error correction data to the GNSS device, wherein at least a portion of the updated GNSS error correction data expires after a predetermined period of time.
Clause 16. The server of any of clauses 10-15, wherein to determine the GNSS measurement residuals, the one or more processors are further configured to: determine a location of the one or more GNSS devices using the multiple GNSS measurements and the existing GNSS error correction data; and determine the GNSS measurement residuals using the location.
Clause 17. The server of any of clauses 10-16, wherein the existing GNSS error correction data comprises SSR data or OSR data.
Clause 18. The server of any of clauses 10-17, wherein the multiple GNSS measurements are processed in a backward fashion and a forward fashion.
Clause 19. An example apparatus for updating GNSS error correction data for global navigation satellite system (GNSS)-based positioning. The apparatus may comprise means for obtaining multiple GNSS measurements crowdsourced from one or more GNSS devices across a plurality of measurement epochs, means for determining GNSS measurement residuals using the multiple GNSS measurements and existing GNSS error correction data, and means for sending updated GNSS error correction data for GNSS-based positioning, wherein the updated GNSS error correction data is determined using the determined GNSS measurement residuals and the existing GNSS error correction data.
Clause 20. The apparatus of clause 19, further comprising: prior to determining GNSS measurement residuals, filtering out low-quality GNSS measurements in the multiple GNSS measurements based on: carrier-to-noise density ratio of the multiple GNSS measurements; carrier phase cycle slips of the multiple GNSS measurements; or any combination thereof; and zoning the multiple GNSS measurements based on one or more pre-defined SSR grids.
Clause 21. The apparatus of any of clause 19 or 20, wherein the multiple GNSS measurements are performed by a plurality of GNSS devices.
Clause 22. The apparatus of any of clauses 19-21, wherein sending the updated GNSS error correction data comprises: means for broadcasting the updated GNSS error correction data according to the zoning.
Clause 23. The apparatus of any of clause of 19 or 20, wherein the multiple GNSS measurements are performed by a same GNSS device.
Clause 24. The apparatus of any of clauses 19-23, wherein sending the updated GNSS error correction data comprises: means for transmitting the updated GNSS error correction data to the GNSS device, wherein at least a portion of the updated GNSS error correction data expires after a predetermined period of time.
Clause 25. The apparatus of any of clauses 19-24, wherein determining the GNSS measurement residuals further comprises: means for determining a location of the one or more GNSS devices using the multiple GNSS measurements and the existing GNSS error correction data; and means for determining the GNSS measurement residuals using the location.
Clause 26. The apparatus of any of clauses 19-25, wherein the existing GNSS error correction data comprises SSR data or OSR data.
Clause 27. The apparatus of any of clauses 19-26, wherein the multiple GNSS measurements are processed in a backward fashion and a forward fashion.
Clause 28. An example non-transitory computer-readable medium storing instructions for RF sensing, the instructions may comprise code for obtaining multiple GNSS measurements crowdsourced from one or more GNSS devices across a plurality of measurement epochs, determining GNSS measurement residuals using the multiple GNSS measurements and existing GNSS error correction data, and sending updated GNSS error correction data for GNSS-based positioning, wherein the updated GNSS error correction data is determined using the determined GNSS measurement residuals and the existing GNSS error correction data.
Clause 29. The computer-readable medium of clause 28, further comprising code for: prior to determining GNSS measurement residuals, filtering out low-quality GNSS measurements in the multiple GNSS measurements based on: carrier-to-noise density ratio of the multiple GNSS measurements; carrier phase cycle slips of the multiple GNSS measurements; or any combination thereof; and zoning the multiple GNSS measurements based on one or more pre-defined SSR grids.
Clause 30. The computer-readable medium of clause 28 or 29, wherein the existing GNSS error correction data comprises SSR data or OSR data.

What is claimed is:

1. A method of updating GNSS error correction data for global navigation satellite system (GNSS)-based positioning, the method performed by a server and comprising:
obtaining multiple GNSS measurements crowdsourced from one or more GNSS devices across a plurality of measurement epochs;
determining GNSS measurement residuals using the multiple GNSS measurements and existing GNSS error correction data; and
sending updated GNSS error correction data for GNSS-based positioning, wherein the updated GNSS error correction data is determined using the determined GNSS measurement residuals and the existing GNSS error correction data.

2. The method of claim 1, further comprising:
prior to determining GNSS measurement residuals, filtering out low-quality GNSS measurements in the multiple GNSS measurements based on:
carrier-to-noise density ratio of the multiple GNSS measurements;
carrier phase cycle slips of the multiple GNSS measurements; or
any combination thereof; and
zoning the multiple GNSS measurements based on one or more pre-defined SSR grids.

3. The method of claim 2, wherein the multiple GNSS measurements are performed by a plurality of GNSS devices.

4. The method of claim 3, wherein sending the updated GNSS error correction data comprises:
broadcasting the updated GNSS error correction data according to the zoning.

5. The method of claim 2, wherein the multiple GNSS measurements are performed by a same GNSS device.

6. The method of claim 5, wherein sending the updated GNSS error correction data comprises:
transmitting the updated GNSS error correction data to the GNSS device, wherein at least a portion of the updated GNSS error correction data expires after a predetermined period of time.

7. The method of claim 1, wherein determining the GNSS measurement residuals further comprises:
determining a location of the one or more GNSS devices using the multiple GNSS measurements and the existing GNSS error correction data; and
determining the GNSS measurement residuals using the location.

8. The method of claim 1, wherein the existing GNSS error correction data comprises SSR data or OSR data.

9. The method of claim 1, wherein the multiple GNSS measurements are processed in a backward fashion and a forward fashion.

10. A server for updating GNSS error correction data for global navigation satellite system (GNSS)-based positioning comprising:
a transceiver;
a memory; and
one or more processors communicatively coupled with the transceiver and the memory, wherein the one or more processors are configured to:
obtain multiple GNSS measurements crowdsourced from one or more GNSS devices across a plurality of measurement epochs;
determine GNSS measurement residuals using the multiple GNSS measurements and existing GNSS error correction data; and
send updated GNSS error correction data for GNSS-based positioning, wherein the updated GNSS error correction data is determined using the determined GNSS measurement residuals and the existing GNSS error correction data.

11. The server of claim 10, wherein the one or more processors are further configured to:
prior to determining GNSS measurement residuals, filter out low-quality GNSS measurements in the multiple GNSS measurements based on:
carrier-to-noise density ratio of the multiple GNSS measurements;
carrier phase cycle slips of the multiple GNSS measurements; or
any combination thereof; and
zone the multiple GNSS measurements based on one or more pre-defined SSR grids.

12. The server of claim 11, wherein the multiple GNSS measurements are performed by a plurality of GNSS devices.

13. The server of claim 12, wherein to send the updated GNSS error correction data, the one or more processors are further configured to:
broadcast the updated GNSS error correction data according to the zoning.

14. The server of claim 11, wherein the multiple GNSS measurements are performed by a same GNSS device.

15. The server of claim 14, wherein to send the updated GNSS error correction data, the one or more processors are further configured to:
transmit the updated GNSS error correction data to the GNSS device, wherein at least a portion of the updated GNSS error correction data expires after a predetermined period of time.

16. The server of claim 10, wherein to determine the GNSS measurement residuals, the one or more processors are further configured to:
determine a location of the one or more GNSS devices using the multiple GNSS measurements and the existing GNSS error correction data; and
determine the GNSS measurement residuals using the location.

17. The server of claim 10, wherein the existing GNSS error correction data comprises SSR data or OSR data.

18. The server of claim 10, wherein the multiple GNSS measurements are processed in a backward fashion and a forward fashion.

19. An apparatus for updating GNSS error correction data for global navigation satellite system (GNSS)-based positioning, the apparatus comprising:
means for obtaining multiple GNSS measurements crowdsourced from one or more GNSS devices across a plurality of measurement epochs;
means for determining GNSS measurement residuals using the multiple GNSS measurements and existing GNSS error correction data; and
means for sending updated GNSS error correction data for GNSS-based positioning, wherein the updated GNSS error correction data is determined using the determined GNSS measurement residuals and the existing GNSS error correction data.

20. The apparatus of claim 19, further comprising:
means for prior to determining GNSS measurement residuals, filtering out low-quality GNSS measurements in the multiple GNSS measurements based on:
carrier-to-noise density ratio of the multiple GNSS measurements;
carrier phase cycle slips of the multiple GNSS measurements; or
any combination thereof; and
means for zoning the multiple GNSS measurements based on one or more pre-defined SSR grids.

21. The apparatus of claim 20, wherein the multiple GNSS measurements are performed by a plurality of GNSS devices.

22. The apparatus of claim 21, wherein sending the updated GNSS error correction data comprises:
means for broadcasting the updated GNSS error correction data according to the zoning.

23. The apparatus of claim 20, wherein the multiple GNSS measurements are performed by a same GNSS device.

24. The apparatus of claim 23, wherein sending the updated GNSS error correction data comprises:
means for transmitting the updated GNSS error correction data to the GNSS device, wherein at least a portion of the updated GNSS error correction data expires after a predetermined period of time.

25. The apparatus of claim 20, wherein determining the GNSS measurement residuals further comprises:
means for determining a location of the one or more GNSS devices using the multiple GNSS measurements and the existing GNSS error correction data; and
means for determining the GNSS measurement residuals using the location.

26. The apparatus of claim 19, wherein the existing GNSS error correction data comprises SSR data or OSR data.

27. The apparatus of claim 19, wherein the multiple GNSS measurements are processed in a backward fashion and a forward fashion.

28. A non-transitory computer-readable medium storing instructions for updating GNSS error correction data for global navigation satellite system (GNSS)-based positioning, the instructions comprising code for:
obtaining multiple GNSS measurements crowdsourced from one or more GNSS devices across a plurality of measurement epochs;
determining GNSS measurement residuals using the multiple GNSS measurements and existing GNSS error correction data; and
sending updated GNSS error correction data for GNSS-based positioning, wherein the updated GNSS error correction data is determined using the determined GNSS measurement residuals and the existing GNSS error correction data.

29. The computer-readable medium of claim 28, further comprising code for:
prior to determining GNSS measurement residuals, filtering out low-quality GNSS measurements in the multiple GNSS measurements based on:
carrier-to-noise density ratio of the multiple GNSS measurements;
carrier phase cycle slips of the multiple GNSS measurements; or
any combination thereof; and
zoning the multiple GNSS measurements based on one or more pre-defined SSR grids.

30. The computer-readable medium of claim 28, wherein the existing GNSS error correction data comprises SSR data or OSR data.
